(19) United States
(12) Patent Application Publication
(10) Pub. No.: US 2026/0025049 A1
(43) Pub. Date: Jan. 22, 2026

(54) VARIABLE RELUCTANCE RESOLVER

(71) Applicant: SAFRAN ELECTRONICS & DEFENSE, Paris (FR)

(72) Inventors: Blaise André Michel LAPÔTRE, MOISSY-CRAMAYEL (FR); Bernard RABRET, MOISSY-CRAMAYEL (FR)

(73) Assignee: SAFRAN ELECTRONICS & DEFENSE, Paris (FR)

(21) Appl. No.: 18/997,977

(22) PCT Filed: Jul. 26, 2023
(86) PCT No.: PCT/FR2023/051180

§ 371 Date: Jan. 23, 2025

(30) Foreign Application Priority Data
Jul. 29, 2022 (FR) 2207879

(51) Int. Cl. H02K 24/00; G01D 5/20; H02K 1/24; H02K 15/022; H02K 15/40

(52) U.S. Cl. CPC H02K 24/00; G01D 5/2046; H02K 1/246; H02K 15/022; H02K 15/40

(57) ABSTRACT

The invention relates to a variable reluctance resolver (10), comprising a rotor (20) and a stator (30) coaxial with the rotor (20), the stator (30) comprising a plurality of teeth (31), two consecutive teeth (31) forming a tooth angle (ΘD), the rotor (20) comprising a stack of elementary strata coaxially stacked along a central axis (X), characterised in that each elementary stratum defines at least one pair of poles (21M, 21m), the stack comprising a first elementary stratum (25) defining the bottom of the stack and at least one upper elementary stratum (26) superimposed on the first elementary stratum (25), each upper elementary stratum (26) being angularly offset by an offset angle (ΘP) about the central axis (X) with respect to the underlying elementary stratum, the offset angle (ΘP) being equal to the tooth angle (ΘD) multiplied by (N−1)/N, N being the number of stacked elementary strata (25, 26).

### FIELD OF THE INVENTION

The present invention relates to a variable reluctance resolver.

### PRIOR ART

A variable reluctance resolver is a type of sensor enabling precise measurement of the angle of rotation of any rotary system. They can be found, in particular, in all machines having electric motors, for example aeronautical actuators or optronic systems. A variable reluctance resolver can also be used as a sensor to return position information (for example of throttle levers, flaps or ailerons).

A variable reluctance resolver comprises a rotating portion, called a rotor, and a fixed portion called a stator. Said portions are arranged concentrically, either in the form of a central rotor and an annular stator placed coaxially around the rotor, or in the form of a central stator surrounded by a rotor comprising an inner cavity. In each configuration, an air gap is formed between the rotor and the stator.

The rotor typically has a rotational symmetry about the common axis with the stator and a geometry such that the width of the air gap delimited between the rotor surface and the facing stator surface varies periodically between a maximum value and a minimum value. For a central rotor, each maximum value of the air gap corresponds to a trough line on the rotor surface of the air gap, and each minimum value of the air gap corresponds to a peak line on said rotor surface. For an outer rotor, each minimum value of the air gap corresponds to a trough line on the rotor surface of the air gap, and each maximum value of the air gap corresponds to a peak line on said rotor surface. Thus, when the rotor turns, the periodic variation in the air gap width is detected and indicates the angle of rotation of the rotor.

The number of peaks and the number of troughs is identical. Each peak and trough pair forms a pair of poles corresponding to a minimum width and a maximum width of the air gap. The stator comprises a toothing formed by an even number of teeth projecting towards the air gap. Said toothing carries windings of electrically conductive wire, such that each winding is wound around the teeth. The set of windings comprises an excitation winding on which an alternating electric voltage with a frequency of several kHz is applied, and at least two angle detection windings at the ends of which an electric voltage is measured. It is possible to have more than two detection windings, for example to ensure the redundancy of information. The signal measured on a detection winding corresponds substantially to a sine curve modulated by the excitation frequency.

However, the signal detected on the detection windings has a toothing harmonic which corresponds to a modulation each time that a pole of the rotor passes in front of a tooth of the stator. This modulation by the toothing harmonic complicates the processing of the detected signal and is detrimental to the precision of the resolver.

A variable reluctance resolver comprising a rotor and a stator coaxial with the rotor is taught, for example, by document US 2013/193957 A1.

### DISCLOSURE OF THE INVENTION

An object of the invention is to propose a variable reluctance resolver making it possible to eliminate the toothing harmonic signals due to the passage of the poles of the rotor in front of each tooth of the toothing of the stator.

For this purpose, the invention proposes a variable reluctance resolver comprising a rotor and a stator coaxial with said rotor with respect to a central axis, said rotor and said stator being separated by an air gap, said stator comprising a stator surface provided with a toothing comprising a plurality of teeth projecting towards said air gap, said teeth being disposed such that two consecutive teeth along the toothing form a tooth angle with respect to the central axis, said rotor comprising a stack of stacked elementary strata (25, 26) coaxial to the central axis, each elementary stratum having an identical geometry in a plane perpendicular to the central axis,
characterised in that, each elementary stratum defines at least one pair of poles arranged on a rotor surface of said air gap, the stack comprising a first elementary stratum defining the bottom of the stack and at least one upper elementary stratum superimposed on said first elementary stratum, each upper elementary stratum being angularly offset by an offset angle about the central axis with respect to the underlying elementary stratum, the offset angle being equal to the tooth angle multiplied by (N−1)/N, N being the number of stacked elementary strata.

Preferably, the rotor comprises m pairs of poles disposed with rotational symmetry with respect to the central axis, m being an integer.

In certain embodiments, the stacked elementary strata are sheet metal elements.

In other embodiments, the stacked elementary strata are layers connected by sintering or by an additive manufacturing technique.

In certain embodiments, each stacked elementary stratum has a thickness between 0.1 mm and 1 mm along the axis.

Each elementary stratum can be made of a solid material.

Alternatively, each elementary stratum of the rotor comprises a superposition of sheet metal elements without angular offset between respective sheet metal elements, with respect to the central axis.

In certain embodiments, the rotor is arranged inside a central cavity of the stator.

In other embodiments, the stator is arranged inside a central cavity of the rotor.

The invention also relates to a system for measuring an angle and/or a speed of rotation, comprising
a variable reluctance resolver as described above,
an AC voltage generator in electrical connection with the ends of the excitation winding,
a time-resolved electric voltage detector in electrical connection with the ends of each detection winding,
a data processing system configured to calculate, from the electric voltages measured by the electric voltage detector, an angle of rotation of the rotor.

The invention also relates to a method for manufacturing a variable reluctance resolver, comprising the following steps:
providing a stator comprising, on a stator face intended to form an air gap with a rotor, a toothing comprising a plurality of teeth, said teeth being disposed such that two consecutive teeth along the toothing form a tooth angle with respect to a central axis,
providing at least two elementary strata of a rotor, each elementary stratum having an identical geometry in a plane perpendicular to the central axis and comprising, on a rotor face intended to delimit an air gap (40) with the stator face of the stator, at least
   one zone set back with respect to a mean circle about the central axis, said zone delimiting a zone of maximum width of said air gap and
   one zone protruding with respect to a mean circle about the central axis, said zone delimiting a zone of minimum width of said air gap,
defining a bottom elementary stratum,
stacking at least one second elementary stratum coaxial with respect to the central axis on the bottom elementary stratum, such that each elementary stratum is angularly offset with respect to an underlying elementary stratum by an offset angle being equal to the tooth angle multiplied by (N−1)/N, N being the number of stacked elementary strata,
fixing the stacked elementary strata to form the rotor,
concentric fitting of the rotor and the stator so as to form an air gap between the stator face of the stator and the rotor face of the rotor.
   Each elementary stratum may have, on its rotor face intended to delimit the air gap with the stator face of the stator, a plurality of pairs of poles or a eccentric structure with respect to the central axis X.

The invention also relates to a method for measuring an angle and/or of a speed of rotation comprising the following steps:
providing a reluctance resolver as described above,
applying an excitation voltage to an excitation winding carried by the toothing,
rotating the rotor relative to the stator about the central axis,
detecting a time-resolved detection voltage at the ends of at least one detection winding carried by the toothing,
calculating, from the time-resolved detection voltage, an angle and/or a speed of rotation.

### BRIEF DESCRIPTION OF THE FIGURES

Other features and advantages of the invention will become apparent from the detailed description which follows with reference to the appended drawings in which:

FIG. 1 illustrates a variable reluctance resolver comprising a central rotor and an annular stator placed coaxially about the rotor.

FIG. 2 illustrates a variable reluctance resolver comprising a central stator surrounded by a rotor comprising an inner cavity.

FIG. 3 is a perspective view of a rotor formed by stacking elementary metal sheets.

FIG. 4 is a perspective view of a rotor comprising a stack of two solid elementary strata.

FIG. 5A shows a variable reluctance resolver comprising a central rotor defining two axisymmetric poles with respect to the central axis X.

FIG. 5B shows a variable reluctance resolver comprising a central rotor defining three axisymmetric poles with respect to the central axis X.

FIG. 5C shows a variable reluctance resolver comprising a central rotor defining four axisymmetric poles with respect to the central axis X.

FIG. 5D shows a variable reluctance resolver comprising a central stator and an outer rotor defining two pairs of poles.

FIG. 5E shows a variable reluctance resolver comprising a central stator and an outer rotor defining a single pair of poles.

FIG. 5F shows a variable reluctance resolver comprising a central rotor and an outer stator defining a single pair of poles

FIG. 6 is a graph of the position error due to the toothing harmonic for a known resolver and a resolver according to the invention.

FIG. 7A illustrates a line of poles of the same rank on a rotor surface of a known rotor.

FIG. 7B illustrates a line of poles of the same rank on a rotor surface of a rotor according to an embodiment of the invention.

FIG. 8 shows the excitation voltage and the voltages measured on the detection coils as a function of the angle of rotation of the rotor.

### DETAILED DESCRIPTION OF THE EMBODIMENTS

### Variable Reluctance Resolver

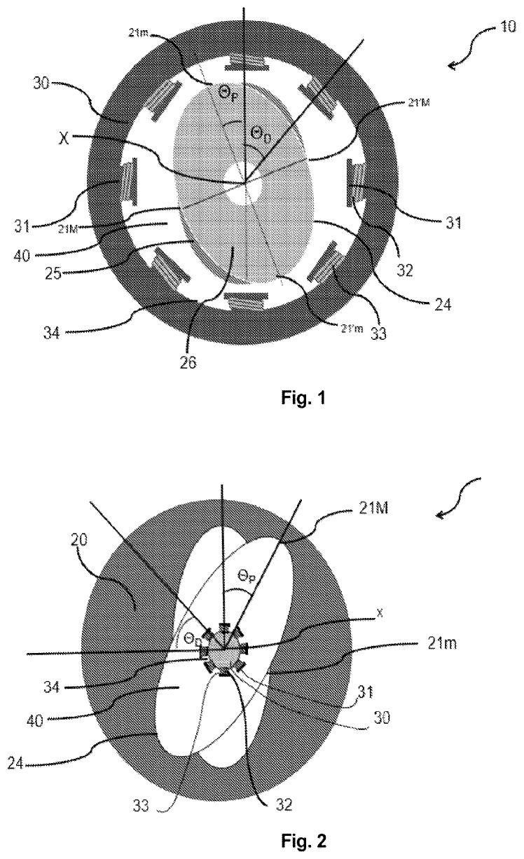

The resolver 10 comprises a rotor 20 and a stator 30 arranged coaxially with respect to a central axis X. In a first embodiment, with reference to FIG. 1, the stator 30 has an annular geometry and the rotor 20 is arranged freely rotating with respect to the central axis X of the resolver. Alternatively, with reference to FIG. 2, the resolver 10 comprises a central stator 30 having a substantially circular geometry, and a freely rotating rotor 20 surrounding the stator 20. The central axis X of the resolver is identical with the central axis of the stator 30 and the axis of rotation of the rotor 20.

The stator 30 and the rotor 20 are separated by an air gap 40 delimited by a stator surface 34 and a rotor surface 24 opposite said stator surface 34.

In known manner, the stator and the rotor are magnetic circuits generally formed of a stack of ferromagnetic material metal sheets, with insertion of an electrical insulator between each metal sheet of a stack, for example an insulating adhesive. Alternatively and likewise known, the rotor and/or the stator are formed from a ferromagnetic material by additive manufacturing, with electrically insulating layers inserted between the ferromagnetic elementary layers.

In addition to the rotor 20 and the stator 30, the variable reluctance resolver 10 may comprise a casing and/or a holding system enabling rotation of the rotor 20 relative to the stator 30 about the central axis X.

### Description of the Stator

The stator 30 has a rotationally symmetric geometry with respect to the central axis X. The cross-section of the stator perpendicular to the central axis X typically has a circular shape in the case of a central stator, or annular shape in the case of an outer stator. Typically, the stator 30 comprises a stack of several elementary strata stacked coaxially along the central axis X, with a dielectric layer inserted between two successive strata in order to avoid electric currents by induction. For example, the stator comprises a laminated core made of stacked ferromagnetic material with a dielectric layer inserted between two successive metal sheets. Alternatively, the stator 30 is made of a solid material with one or more slices in the direction of the central axis X and comprises, where appropriate, a dielectric layer between two successive slices. In certain cases, the stator 30 comprises elementary layers manufactured, for example, by a sintering or additive manufacturing method.

The elementary strata of the stator 30 are typically made of a ferromagnetic material having small hysteresis cycles, for example an alloy comprising iron and nickel.

The stator surface 34 is equipped with a toothing comprising a plurality of teeth 31. The teeth 31 are preferably arranged radially with respect to the central axis X and project towards the air gap 40 between the rotor 20 and the stator 30. Typically, each tooth 31 comprises a thinner portion connected with the circular or annular portion of the stator 30, said thinner portion being able to support one or more windings 32, 33. The end of each tooth 31 towards the air gap is advantageously wider, forming a stop for holding the windings 32, 33 in place. The teeth 31 are typically formed in the metal sheets or elementary layers forming the stator 30.

The teeth 31 are arranged in rotational symmetry with respect to the central axis X. Two consecutive teeth 31 along the toothing together form a tooth angle Θ_{D} with respect to the central axis X. For example, for a toothing comprising 10 teeth, the angle Θ_{D} is equal to 36°. The number of teeth is typically between 8 and 20, thus forming angles Θ_{D} between 45° and 18°.

The stator 30 comprises an excitation winding 32 and one or more detection windings 33 arranged on the teeth of the toothing. The windings 32, 33 are made of an electrically conductive wire, for example a copper wire, carrying an electrical insulator. The ends of the excitation winding 32 can be electrically connected to an AC power source, generally an AC voltage generator or a sinusoidal current generator, and the ends of each detection winding 33 can be electrically connected to a voltage detector.

The detection windings 33 are arranged on the toothing such that the voltages at the output of the detection windings 33 are signals with sinusoidal or cosinusoidal waveforms, phase-shifted by 90° for example. This phase shift makes it easy to measure an angular position, which enabling a speed to be deduced from a variation of the air gap due to the rotation of the rotor. The number of turns of the excitation and detection windings on each tooth is chosen such that, during the rotation of the rotor, an excitation by the voltage or current generator creates a sinusoidal or cosinusoidal induced voltage in the detection windings, depending on the angular position.

### Description of the Rotor

The rotor 20 is coaxial with the stator 30 and freely rotating with respect to the stator 30 about the central axis X.

The rotor 20 comprises a stack of several elementary strata 25, 26 coaxially stacked along the central axis X. Preferably, the elementary strata 25, 26 of the rotor 20 are identical, i.e. they have the same shape and the same thickness. Thus, the elementary strata 25, 26 can be easily manufactured by the same device, for easier and quicker manufacture. In addition, identical elementary strata 25, 26 are easier to stack regularly. The elementary strata 25, 26 of the rotor 20 are typically made of a ferromagnetic material having small hysteresis cycles, for example an alloy comprising iron and nickel.

In the case of a central rotor, the rotor typically has a circular recess at the centre. This recess can be provided with a key or a notch (not shown) for indexing the original position of the rotary system.

The section of the rotor 20 perpendicular to the central axis X is typically not circular in the case of a central rotor, or perfectly annular in the case of an outer rotor, but the geometry of the section is chosen such that the reluctance of the interval between the rotor and the windings of the stator 1 varies sinusoidally. For this purpose, the rotor surface 24 delimiting the air gap 40 formed between the rotor 20 and the stator 30 has, on its periphery, a succession of protruding zones alternating with set-back zones, in the radial direction defining a periodic succession of maxima 21M, 21′M of width of the air gap alternating with minima 21m, 21′m of width of the air gap, determining as many pairs of poles (by analogy with the North and South pairs of poles of a magnet).

The protruding zone forms a zone of the air gap having a minimum width 21m, and the set-back zone forms a zone of the air gap having a maximum width 21M with respect to the other zones of the air gap.

For each section of a rotor, a mean circle CM can be defined having the same area as the cross-sectional plane of the rotor in the case of the central rotor, and the same area as the inner cavity in the case of an outer rotor. The protruding and set-back zones are to be understood with respect to this mean circle.

For example, in the case of an inner rotor having an elliptical geometry, the protruding zone corresponds to the major axis of the ellipse and the set-back zone corresponds to the minor axis of the ellipse. In the case of an outer rotor having an ellipsoidal cavity, the protruding zone corresponds to the edge adjacent to the minor axis of the ellipsoidal cavity, and the set-back zone to the edge at the major axis of the ellipsoidal cavity.

Alternatively, the rotor comprises an eccentric structure with respect to the central axis X defining a single pair of poles. In this case, the protruding zone is to be understood as being the portion of the rotor furthest away from the central axis X. The set-back zone is the portion opposite the protruding zone, wherein the distance between the circumference of the rotor and the central axis X is minimal.

For an outer rotor having a single pair of poles, the protruding zone is therefore the zone in which the rotor comes closest to the central stator, and the set-back zone is to be understood as the zone in which the distance between the surface of the rotor and the stator is maximal.

The protruding zones and the set-back zones of each elementary stratum 25, 26 of the prospective rotor 20 are angularly offset with respect to the protruding zones and the set-back zones of adjacent elementary strata.

An elementary stratum 25, 26 of the rotor 20 can be thin, for example of a thickness between 100 and 500 μm. In this case, a plurality of elementary strata is stacked in order to form the rotor, for example between 5 and 100 elementary strata in order to attain a thickness of the rotor 20 between 2 and 10 mm. A thin elementary stratum 25, 26 is, for example, an elementary metal sheet cut out of a ferromagnetic metal sheet, for example by stamping. In this case, as illustrated in the FIG. 3, the elementary metal sheets forming the rotor 20 are stacked along the central axis X and bonded together after the adjustment of the axial stack and the adjustment of the offset of the protruding zones and set-back zones. In other embodiments, a thin elementary stratum 25, 26 can be an elementary layer in an additive manufacturing method, or a thickness of a material intended to be connected to other successive thicknesses by a sintering method.

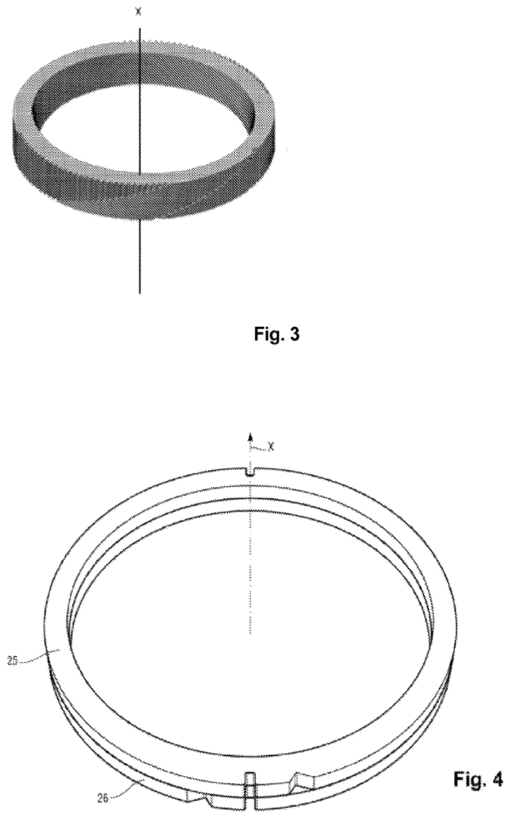

Alternatively, an elementary stratum 25, 26 can have a larger thickness than that of an elementary metal sheet. For example, an elementary stratum 25, 26 comprises a stack of elementary metal sheets, preferably identical. In this case, the metal sheets in each elementary stratum are stacked flush with the surface, without offset or torsion between the respected elementary metal sheets. In other embodiments, one or more elementary strata 25, 26 can be formed of a solid ferromagnetic material, for example an iron-nickel alloy, using a machining or moulding method. Such a rotor 20 comprising two such elementary strata 25, 26 having a certain thickness is illustrated in FIG. 4.

In a rotor 20, each elementary stratum 25, 26 comprises the same number m of protruding zones, corresponding to peaks, and set-back zones corresponding to valleys on the rotor face 24 of the air gap 40. The peak zones protrude radially in the direction of the air gap. In addition to 2 poles, set-back zones (valleys) are formed between adjacent protruding zones (peaks). In other words, the rotor surface comprises a succession of peaks and valleys alternating periodically in the circumferential direction. The protruding zones and the set-back zones of each respective elementary stratum 25, 26 are typically arranged in rotational symmetry about the central axis X, i.e. in periodic succession.

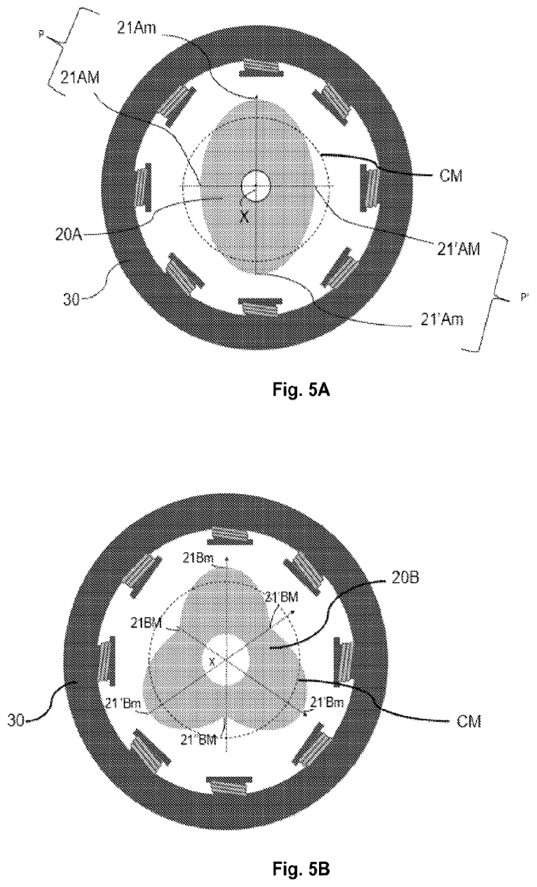

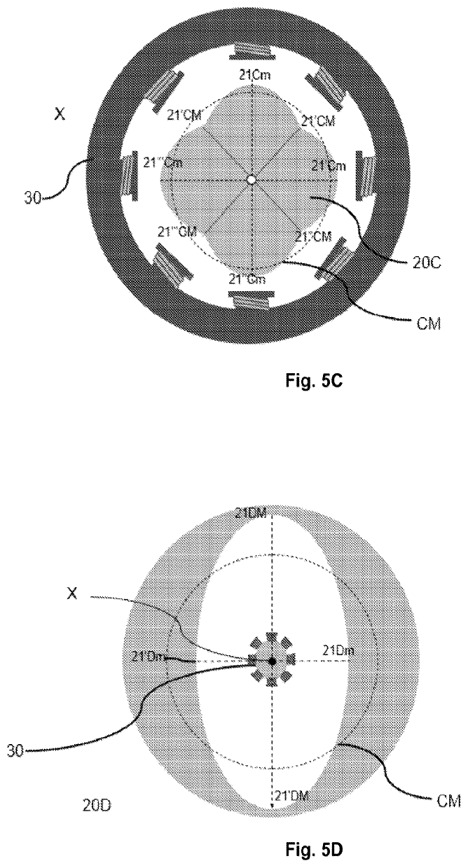

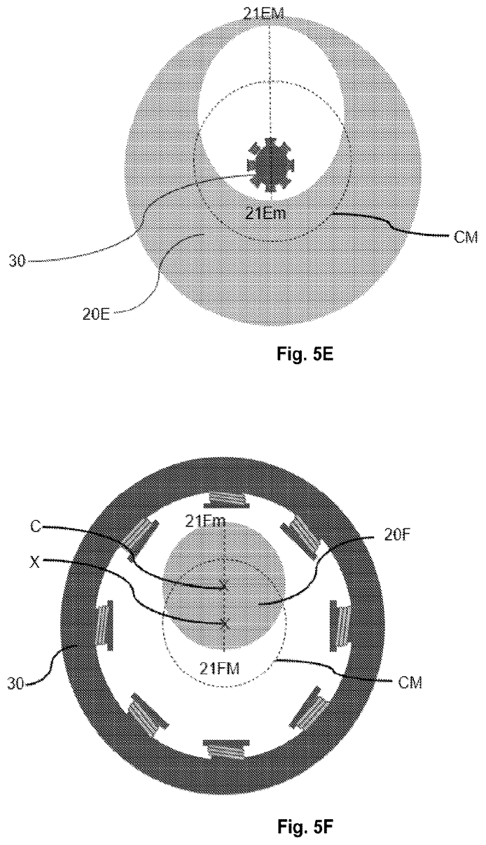

FIGS. 5A to 5F illustrate the geometry of a single respective elementary stratum in the plane of the stack of the rotor for various rotor configurations. The position and geometry of the stator are indicated for understanding of these figures.

In the case of a central rotor 20, with reference to FIG. 5A, each elementary stratum 25, 26 of the rotor 20A can have an oval or elliptical shape, including the two peaks corresponding to the two minimum widths of the air gap and the two set-back zones corresponding to the two maximum widths, the whole defining two pairs of poles P and P′. The pair of poles P comprises a maximum air gap width 21AM and a minimum 21Am air gap width, and the pair of poles P′ comprises a maximum air gap width 21′AM and a minimum air gap width 21′Am. The two pairs of poles are offset by 180° on the surface of the elementary stratum 20A of the rotor.

With reference to FIG. 5B, such an elementary stratum of the rotor 20B can have a rotational symmetry at every 120°. Such a rotor comprises three pairs of poles: a pair of poles P comprising the maximum 21BM and the minimum 21Bm, pair P4 comprising the maximum 21′BM and the minimum 21′Bm and a third pair P″ comprising the maximum 21″BM and the minimum 21″Bm. The three air gap width maxima 21BM, 21′BM and 21″BM are arranged at the vertices of a first equilateral triangle, and the three air gap width minima 21Bm, 21′Bm and 21″Bm at the vertices of a second equilateral triangle, in the opposite direction to the first triangle.

Alternatively, with reference to FIG. 5C, the rotational symmetry can be every 90°, defining four pairs of poles P, P′, P″ and P′″ equidistant along the contour of the elementary stratum 20C of the rotor. The pairs are defined equivalently to those of the 3 pairs of poles and comprise the maxima 21CM, 21C′M, 21″CM and 21″CM and the minima 21Cm, 21′Cm, 21″Cm and 21″Cm. Elementary strata having a higher number of pole pairs having equivalent geometries, the protruding and set-back zones being arranged symmetrically on the periphery of the elementary stratum of the rotor.

In the case of a central stator 30, each elementary stratum of the rotor 20 has a generally annular shape, having set-back zones and protruding zones with respect to the mean circle CM in the direction of the air gap 40. In the case of two or more poles, the inner cavity is arranged centrally and symmetrically about the central axis X which corresponds to the central axis of the outer perimeter of the rotor.

For example, with reference to FIG. 5D, the inner cavity of an elementary stratum 20B of the rotor can have an oval or elliptical shape. The two vertices of the ellipse correspond to two set-back zones with respect to the mean circle on the inner surface of the elementary stratum. These cavity vertices 21DM and 21′DM delimit the zones in which the air gap is maximal. The protruding zones 21Dm and 21′Dm with respect to the mean circle CM are arranged at the ends of the minor axis of the ellipse and delimit the zones in which the air gap is minimal.

Thus, the axes of the ellipse define two poles P comprising a maximum 21DM and a minimum 21Dm and P′ comprising a maximum 21′DM and 21′Dm. The pairs of poles P and P′ are offset by 180° on the inner periphery of the cavity.

In an equivalent manner to the shapes of a central rotor, an inner cavity of such an elementary stratum can have a geometry of revolution about the axis of rotation defining 3, 4 or more axisymmetric poles equidistant on the periphery of the central cavity.

In the case of a single pair of poles P, with reference to FIG. 5E, the inner cavity is typically an eccentric circle comprising a zone 21EM delimiting a maximum zone of the air gap, and a zone 21Em delimiting a minimum zone of the air gap. In this case, the stator 30 is placed in a central axis X which corresponds to the centre of the outer perimeter of the rotor 20E. The position and the size of the eccentric cavity are chosen so as to create a sufficient space around the central axis X for positioning the stator 30 and for forming an air gap 40 between the rotor 20E and the stator 30. In this case, the decentring of the circular cavity with respect to the mean circle CM defines the position of the poles.

FIG. 5F illustrates the case of an inner rotor having a single pole. In this case, each elementary stratum is circular, the axis de rotation X of the rotor being eccentric with respect to the centre C of the circle of the elementary stratum. This eccentricity defines a pole 21FM corresponding to the air gap maximum, and a pole 21Fm corresponding to the air gap minimum.

### Manufacture of the Rotor

The manufacture of a rotor 20 according to the invention starts by providing a bottom elementary stratum 25 which can have a thin thickness, such as an elementary metal sheet or a first layer in an additive manufacturing method, or an elementary stratum having a more consequential thickness, for example a laminated core, a superposition of several layers in additive manufacturing, or an elementary stratum made of a solid material obtained from a solid material, for example by machining. A mean circle CM is defined which corresponds, in the case of a central rotor, to a circle the centre of which passes through the central axis of the rotor and the area of which is equal to the area of the elementary stratum perpendicular to said central axis X. The bottom elementary stratum 25 has at least one protruding or set-back zone with respect to the mean circle CM or an eccentric structure with respect to the central axis X on the surface intended to form the rotor surface 24 of the air gap between the rotor 20 and the stator 30 of the resolver to be manufactured. This protruding or set-back zone or eccentric structure with respect to the central axis X defines at least one pair of poles 21 for modulating the electric signal in a detection winding 33 of the stator 30 during passage in front of said winding 33. In the case of a single pair of poles, the elementary stratum thus has a single protruding zone and a single set-back zone. Such a geometry corresponds to an eccentric structure with respect to the axis X.

A second elementary stratum 26 is then stacked on said bottom elementary stratum 25. The second elementary stratum is angularly offset from the elementary stratum of the bottom with respect to the central axis of the stack. In the case of a central rotor 20, the central axis corresponds to the centre of the rotor 20. In the case of an outer rotor 20, the central axis X is defined by the centre of the outer perimeter of the rotor 20 and the plane of each elementary stratum 25, 26.

The elementary strata 25, 26 of the rotor are rigidly joined together, for example by an adhesive, by sintering or by manufacture from a single piece. The elementary strata 25, 26 can be fixed during the stacking of each respective elementary stratum 25, 26, and/or after finalisation of the stack. The elementary strata 25, 26 rotate together during the operation of the variable reluctance resolver 10.

### Angular Offset Between the Elementary Strata of the Rotor

The protruding zones and the set-back zones or the eccentric structure with respect to the central axis X of each respective elementary stratum 25, 26 of the rotor are angularly offset with respect to the protruding zones and set-back zones of the other elementary strata 25, 26. The offset angle Θ_{P} is defined between two directly adjacent elementary strata 25, 26. The angle Θ_{P} corresponds to the smallest angle formed between a pole 21 defined by an elementary stratum 25, 26 of the rotor 20, and a pole 21 formed by an adjacent elementary stratum 25, 26 of the rotor 20. The offset angle Θ_{P} between a pole 21 of a first elementary stratum 25, and a pole 21 of an adjacent elementary stratum 26 is therefore defined by using the poles 21 closest to the two respective elementary strata 25, 26.

The offset angle Θ_{P} between two elementary strata 25, 26 of the rotor 20 is chosen as a function of the tooth angle Θ_{P} of the stator 30 and the total number N of elementary strata 25, 26 of the rotor.

In general, the offset angle Θ_{P} is equal to the tooth angle Θ_{D} multiplied by (N−1)/N, N being the number of elementary strata 25, 26 of the rotor 20:

$${θ}_{p} = {θ}_{d} \frac{( N - 1 )}{N}$$

Thus, the poles 21 of the various elementary strata 25, 26 are distributed regularly over the space between two consecutive teeth 31 of the stator 30, or in the zone around a tooth 31, without passing in front of the adjacent tooth 31. Such a distribution of the pole 21 over a portion of the circumference of the rotor 20 makes it possible to reduce the effect of the passage of the pole 21 in front of a tooth 31 of the stator 30 and the electric signal associated with this passage.

For example, with reference to FIG. 1, when the rotor 20 comprises two elementary strata 25, 26 (N=2), the offset angle Θ_{D} between the elementary stratum of the bottom 25 and the upper elementary stratum 26 of the stack corresponds to half of the tooth angle Θ_{D}. When a pole 21 of the lower elementary stratum 25 is situated directly in front of a tooth 31 of the toothing, the pole 21 closest to the upper elementary stratum 26 is situated in the middle between the same tooth 31 and the adjacent tooth 31.

Such an offset angle Θ_{D} can considerably reduce the toothing harmonic of the detected signal, or even completely eliminate the toothing harmonic. This reduction or even removal considerably increases the precision of the resolver 10.

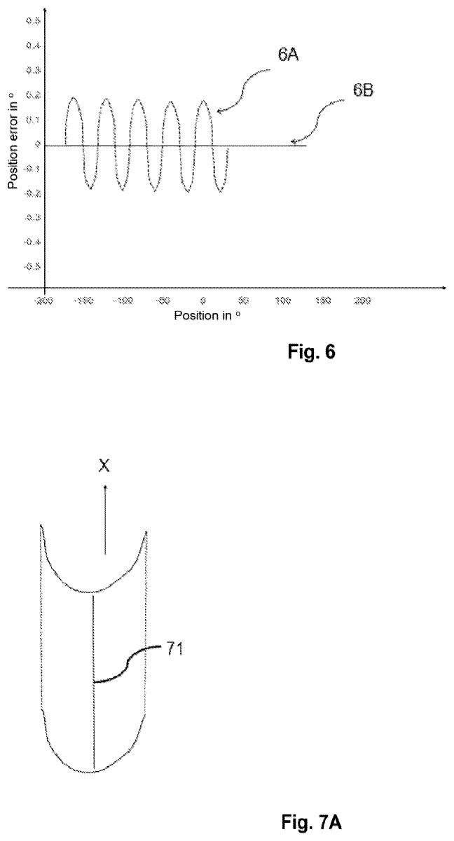

FIG. 6 is a graph of the position error of the rotor in degrees, as a function of the angular position of the rotor in degrees. For a known rotor without angular offset (curve 6A), this error corresponds to the toothing harmonic. In an example, this error varies between 0.2° and −0.2°. For a rotor according to the invention (curve 6B), comprising elementary strata 25, 26 angularly offset according to equation (1), the toothing harmonic is eliminated and the position error is negligible.

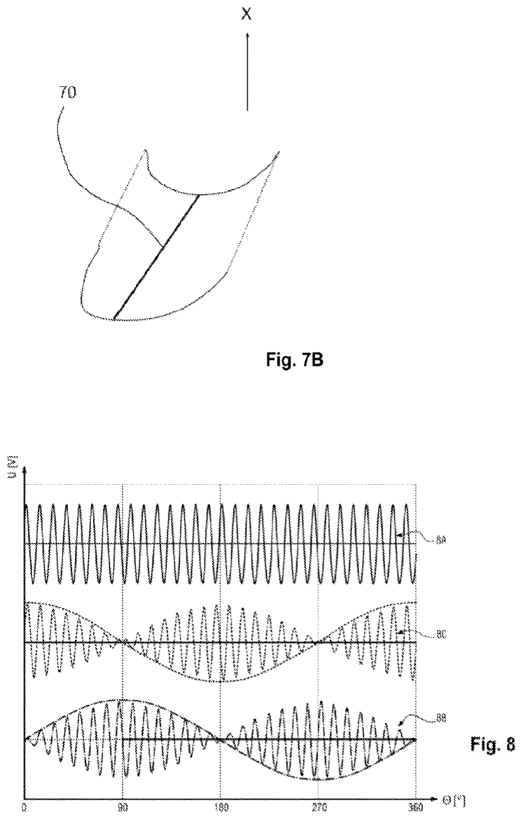

FIG. 7A shows a front view of a portion of a known rotor, at a line of poles of same rank on a rotor surface of the air gap. The poles of the elementary strata form a line of poles 71 corresponding to a maximum (for an outer rotor) or a minimum (for a central rotor) width of the air gap.

Such a line of poles 71 corresponds to a directrix line parallel to the central axis X, all the poles are therefore directly superimposed without angular offset. In cylindrical coordinates, a line of poles of same rank of such a rotor corresponds to the set of points having the same radial and angular coordinates, in other words only the altitude in the stack varies for the poles of the respective elementary strata. During the rotation of the rotor, all the points of a line of poles pass simultaneously in front of a tooth of the stator.

FIG. 7B illustrates a line of poles 70 of the same rank on a rotor surface of a rotor according to a possible embodiment of the invention. The poles of the respective elementary strata have an almost continuous angular offset. The line 70 formed by such poles produces a track in the form of a spiral on the rotor surface of the air gap.

In cylindrical coordinates, the set of points of a line 70 of poles of same rank, always corresponds to a set of points having the same radial coordinates, but these points have an offset of the angular coordinates. Thus, the altitude and the angular position of the poles varies almost continuously in the stack, varies for the poles of the respective elementary strata. Consequently, during the rotation of the rotor about the central axis X, there is a time offset between the passage of each of the points of the line in front of each tooth of the stator.

A System for Measuring an Angle and/or a Speed of Rotation

A system for measuring an angle and/or a speed of rotation comprises a resolver according to the invention, an AC voltage source electrically connected to the excitation winding of the stator, and a device for detecting time-resolved electric voltage in order to detect the signal at the detection windings of the stator.

The measuring system further comprises a device for receiving and processing signals configured to calculate a speed and an angle of rotation.

Such a device measures a time-resolved electric voltage for each detection winding. It comprises a computer tool configured to analyse the electric signal measured on the detection windings in order to monitor the angular position of the rotor and to calculate an angle and/or an angular speed on the basis of the detection curves.

### Measured Signal

FIG. 8 shows the excitation signal applied on the excitation winding of the stator (curve 8A) and the signal from a sine detection winding (curve 7B) and a so-called cosine detection winding having a phase shift of 90° with respect to the sine detection winding (curve 8C).

The excitation signal is a regular alternating voltage, at a frequency typically between 2 and 20 kHz. Each detection signal corresponds to a sinusoidal curve corresponding to the passage of a pole of the rotor in front of the corresponding winding of the stator, modulated by the frequency of the excitation signal. The frequency of the enveloping sine wave is therefore the frequency of rotation of the rotor, divided by the number of poles. The phase shift between the various curves enables the angular position of the rotor to be calculated.

In the case of a known rotor without angular offset, the detection signal further comprises a position error as illustrated in curve 6A of FIG. 6. In the case of a rotor according to the invention, the angular position error due to the toothing harmonic is strongly reduced or even eliminated.

Due to the fact that the position error in the measured signal is eliminated, the speed and angle of rotation can be determined with improved precision.

For example, a resolver 10 comprising a known rotor without angular offset and a stator comprising a number of teeth N=10 can lead to an angular position error of more than 0.16° for the tenth harmonic, while the position error is considerably less for the other harmonics not corresponding to the number of teeth of the stator. Such an angular position error due to the harmonic of rank N is caused by the passage of all the poles of the rotor in a single instant in front of the teeth of the stator.

For the rotor 20 according to the invention, the passage of the poles 21 of the same rank in front of each tooth 31 of the stator takes place in a temporally offset manner in relation to their angular offset. The also creates an average of the errors related to the physical system. Thus, the result measured corresponds to the average of all these angles read at the same time. During the passage of a line of poles 21 of the same rank of the first elementary stratum 25 of the rotor 20 in front of a tooth 31 of a stator 30, the lines of poles 21 of the same rank of the other portions of the rotor 26 are situated at intermediate positions between two adjacent teeth 31. During the passage of the line of poles 21 of the second elementary stratum 26 of the rotor in front of the same tooth 31 of the stator 30, the pole 21 of the first elementary stratum 25 is already located beyond said tooth 31. The potential successive elementary strata are again positioned in front of the same tooth 31. Thus, the passage of the lines of poles 21 in front of each tooth 31 of the stator 30 is smoothed over time, which has the effect of eliminating the toothing harmonic error.

The errors having a higher harmonic rank can have significant consequences when it is desired to obtain the speed of the system. By eliminating them by smoothing the passage of the poles in front of the toothing, using a rotor 20 according to the invention, it is possible to produce high precision resolvers.

### Applications

The resolver 10 according to the invention is used, in particular, in the case of applications in the field of aeronautics, for monitoring an angle of a piece of equipment of an aircraft, in particular for monitoring positions of rotation of electric motors of small or medium power actuators, and more generally for monitoring any rotary system (optronic systems with electric motor, wheel rotation, fans, etc.). It can also be used as a sensor for sending position information (throttle levers, flaps, ailerons, etc.).

### REFERENCES

US 2013/193957 A1

1. A variable reluctance resolver, comprising a rotor and a stator coaxial with said rotor with respect to a central axis,
said rotor and said stator being separated by an air gap,
said stator comprising a stator surface provided with a toothing comprising a plurality of teeth projecting towards said air gap, said teeth being disposed such that two consecutive teeth along the toothing form a tooth angle with respect to the central axis,
said rotor comprising a stack of elementary strata stacked coaxially with the central axis, each elementary stratum having an identical geometry in a plane perpendicular to the central axis,
each elementary stratum defining at least one pair of poles arranged on a rotor surface of said air gap, the stack comprising a first elementary stratum defining the bottom of the stack and at least one upper elementary stratum superimposed on said first elementary stratum,
each upper elementary stratum being angularly offset by an offset angle about the central axis with respect to the underlying elementary stratum, and
the offset angle being equal to the tooth angle multiplied by (N−1)/N, N being the number of stacked elementary strata.

2. The variable reluctance resolver according to claim 1, wherein the rotor comprises m pairs of poles disposed with rotational symmetry with respect to the central axis, m being an integer.

3. The variable reluctance resolver according to claim 1, wherein the stacked elementary strata are sheet metal elements.

4. The resolver according to claim 1, wherein the stacked elementary strata are layers connected by sintering or by an additive manufacturing technique.

5. The resolver according to claim 1, wherein each stacked elementary stratum has a thickness between 0.1 mm and 1 mm along the axis.

6. The resolver according to claim 5, wherein each elementary stratum is made of a solid material.

7. The resolver according to claim 5 wherein each elementary stratum of the rotor comprises a superposition of sheet metal elements without angular offset between respective sheet metal elements with respect to the central axis.

8. The variable reluctance resolver according to claim 1, wherein the rotor is arranged inside a central cavity of the stator.

9. The variable reluctance resolver according to claim 1, wherein the stator is arranged inside a central cavity of the rotor.

10. A system for measuring an angle and/or a speed of rotation, the system comprising:
a variable reluctance resolver according to claim 1,
an AC voltage generator in electrical connection with the ends of the-excitation winding,
a time-resolved electric voltage detector in electrical connection with the ends of each detection winding, and
a data processing system configured to calculate, from the electric voltages measured by the electric voltage detector, an angle of rotation of the rotor.

11. A method for manufacturing a variable reluctance resolver, the method comprising:
providing a stator comprising, on a stator face intended to form an air gap with a rotor, a toothing comprising a plurality of teeth, said teeth being disposed such that two consecutive teeth along the toothing form a tooth angle with respect to a central axis,
providing at least two elementary strata of a rotor, each elementary stratum having an identical geometry in a plane perpendicular to the central axis and comprising, on a rotor face intended to delimit an air gap with the stator face of the stator, at least
one zone set back with respect to a mean circle about the central axis, said zone delimiting a zone of maximum width of said air gap, and
one zone protruding with respect to a mean circle about the central axis, said zone delimiting a zone of minimum width of said air gap,
defining a bottom elementary stratum,
stacking at least one second elementary stratum coaxially with respect to the central axis on the bottom elementary stratum, such that each elementary stratum is angularly offset with respect to an underlying elementary stratum by an offset angle being equal to the tooth angle multiplied by (N−1)/N, N being the number of stacked elementary strata,
fixing the stacked elementary strata to form the rotor, and
concentric fitting of the rotor and the stator so as to form an air gap between the stator face of the stator and the rotor face of the rotor.

12. A method for measuring an angle and/or a speed of rotation, the method comprising the following steps:
providing a reluctance resolver according to claim 1,
applying an excitation voltage to an excitation winding carried by the toothing,
rotating the rotor relative to the stator about the central axis,
detecting a time-resolved detection voltage at the ends of at least one detection winding carried by the toothing, and
calculating, from the time-resolved detection voltage, an angle and/or a speed of rotation.
